(19) United States
(12) Patent Application Publication
(10) Pub. No.: US 2014/0108901 A1
(43) Pub. Date: Apr. 17, 2014

(54) Web Browser Bookmark Reconciliation

(71) Applicant: INTERNATIONAL BUSINESS MACHINES CORPORATION, Armonk, NY (US)

(72) Inventors: Donatello Carriero, Rome (IT); Fabio D'Alfonso, Rome (IT); Marco Imperia, Rome (IT); Patrizia Manganelli, Rome (IT)

(73) Assignee: International Business Machines Corporation, Armonk, NY (US)

(21) Appl. No.: 13/654,220

(22) Filed: Oct. 17, 2012

(51) Int. Cl. G06F 17/21

(52) U.S. Cl. 715/206

(57) ABSTRACT

Mechanisms are provided for reconciling a broken bookmark in a web browser application executing on the data processing system. A selection of a bookmark from a bookmark listing of the web browser application is received. The selected bookmark is determined to be broken in response to an original reference to content associated with the selected bookmark not resulting in the content being retrievable. The mechanisms, in response to the determination that the selected bookmark is broken, performs a search of a local history data structure of the web browser application for a replacement reference to content to replace the original reference to content associated with the selected bookmark. The selected bookmark is updated based on the replacement reference to content.

### BACKGROUND

The present application relates generally to an improved data processing apparatus and method and more specifically to mechanisms for performing web browser bookmark reconciliation.

A web browser is an application that is executed on a computing device, such as a client computing device, for communicating with, and rendering, content from remote computing devices over one or more data networks, such as the Internet, or World Wide Web (hence leading to the name “web” browser). A user may use a web browser to navigate to various web pages provided by one or more web servers. In navigating from one web page to another, a user may identify web pages of particular interest that they would like to frequent in the future. As a shortcut to these web pages, a user may create a “bookmark” to the web site.

A “bookmark” is a mechanism for storing a uniform resource locator (URL) of a web page in the web browser user interface in association with a brief title, description, or designator of the URL. In this way, the next time the user wants to open that web page, the user need only select the bookmark from a listing of the local archive of bookmarks or otherwise directly type its title in the web browser location bar rather than having to type in the complete URL for the web page.

Bookmarks provide a permanence of URLs such that they can provide quick accessibility to the corresponding web pages. A main drawback of bookmarks is that they may become obsolete and useless every time the web page is moved or renamed so that the bookmark can point to a web page that no longer exists, or more troublesome, is a different web page than the original one that is of interest to the user.

Most web browser users leave bookmarks as they are since they do not want to waste time and create additional frustration to update or simply remove the bookmarks manually. Thus, web browsers may become overly populated with broken or obsolete bookmarks.

### SUMMARY

In one illustrative embodiment, a method, in a data processing system, is provided for reconciling a broken bookmark in a web browser application executing on the data processing system. The method comprises receiving, in the data processing system, a selection of a bookmark from a bookmark listing of the web browser application. The method further comprises determining, by the data processing system, that the selected bookmark is broken in response to an original reference to content associated with the selected bookmark not resulting in the content being retrievable. Moreover, the method comprises performing, by the data processing system in response to the determination that the selected bookmark is broken, a search of a local history data structure of the web browser application for a replacement reference to content to replace the original reference to content associated with the selected bookmark. In addition, the method comprises

updating, by the data processing system, the selected bookmark based on the replacement reference to content.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is an example block diagram of the primary operational elements of a client computing device and web browser in accordance with one illustrative embodiment;

FIG. 4 is an example diagram of a listing of potential replacement web page URLs in accordance with one illustrative embodiment;

FIG. 5 is an example diagram of a bookmark update user interface in accordance with one illustrative embodiment; and

FIG. 6 is a flowchart outlining an example operation of a bookmark reconciliation engine in accordance with one illustrative embodiment.

### DETAILED DESCRIPTION

The illustrative embodiments provide mechanisms for performing web browser bookmark reconciliation. The mechanisms of the illustrative embodiments automatically reconcile the bookmarked web pages, or uniform resource locators (URLs) of the web pages, by processing the history and bookmarks to discover the correct URL to be associated with a bookmark whenever the current bookmarked URL cannot be found. The mechanisms of the illustrative embodiments leverage the web page header to associate with a discovered URL its relative reliability. This automated mechanism resolves the ambiguities of the local web browser bookmarks without requiring any change to the web servers or the web pages themselves.

With the mechanisms of the illustrative embodiments, when a user opens his/her web browser and selects a bookmark from a bookmark list in the web browser interface, the selection of the bookmark causes the web browser to enter the corresponding URL in the navigation bar of the web browser, thereby causing the computing device to transmit a request for the corresponding web page from the web server corresponding to the URL. A determination is made as to whether the web page corresponding to the URL is correctly retrieved by the web browser. Typically, if a request for a web page is fulfilled, the Hypertext Transfer Protocol (HTTP) returns a code “200” indicating that the web page was returned successfully. If the return code is different from “200”, then a determination is made to see if the HTTP return code is “404” indicating that a web page matching the URL was not able to be found by the web server. If the return code is something other than “200” or “404”, then the web browser will continue to process the web page request and returned web page content in accordance with a conventional operation generally known in the art.

In the event that the return code is “404”, the bookmark reconciliation engine of the illustrative embodiments is invoked by the web browser which then performs a search to find a replacement URL for the bookmark that led to the return code of “404.” In order to identify the replacement URL, the bookmark reconciliation engine performs a search of the web browser history based on information about the bookmark and its previous URL which is determined to be “broken,” e.g., keywords, title, one or more portions of a URL, last visit date, visit count, and the like). This information may be used to perform matching operations with corresponding information associated with other URLs in the web browser history. Various weightings may be associated with different parameters in this information based on a relative importance applied to these parameters. A confidence level value may be calculated for each of these other URLs based on these weighted parameter values.

In one illustrative embodiment, the confidence level may be used to automatically select a replacement URL for the bookmark, e.g., a URL having a highest confidence level may be selected. In another illustrative embodiment, the confidence levels of the various URLs may be used to generate and present to a user a listing of potential replacement URLs from which the user may select a replacement URL for the bookmark. The generation and presentation of such a listing may be limited to only URLs whose confidence level is above a predetermined threshold value. Based on a user's manual selection of a replacement URL for the bookmark, the bookmark may be updated to be associated with the replacement URL or may be deleted and replaced with a new bookmark corresponding to the replacement URL.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

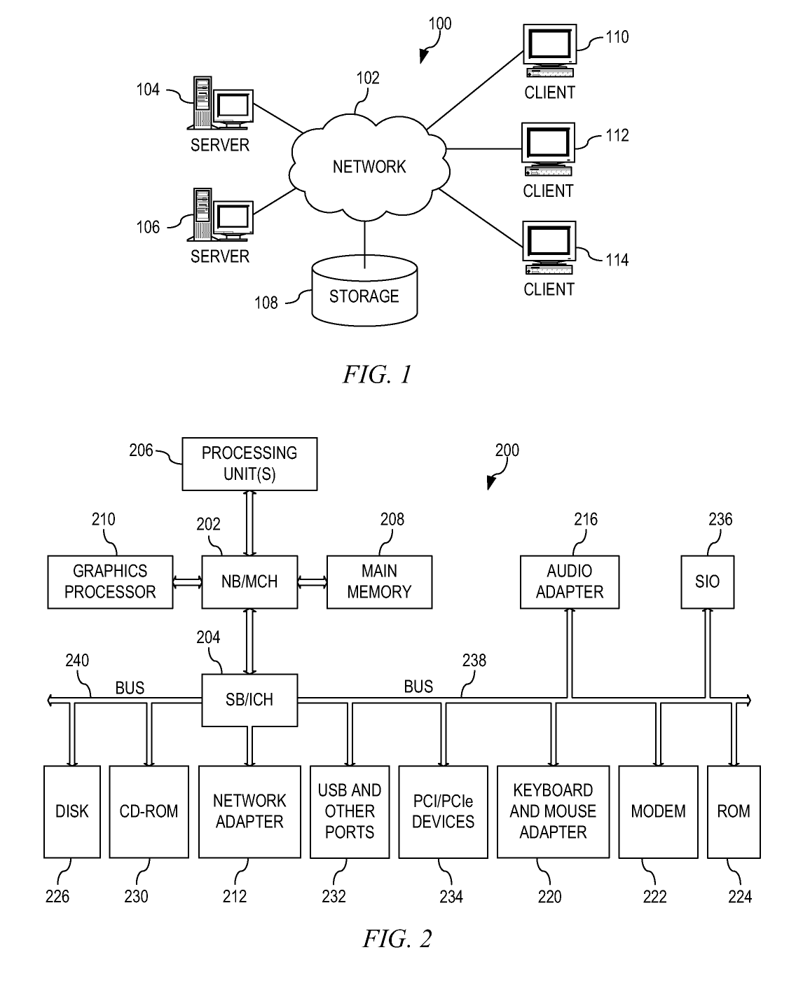

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCl/PCIe devices 234 connect to SB/ICH 204 through bus 238 and bus 240. PCl/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

In accordance with the illustrative embodiments, and with reference again to FIG. 1, one or more of the client computing devices 110-114 may have an installed web browser application in which the engines, elements, and functionality of the present invention are implemented to facilitate the reconciliation of broken bookmarks stored in association with the web browser applications. That is, the web browser application of a client computing device may store bookmarks, i.e. shortcuts, links, or copies of the address, e.g., Uniform Resource Locator (URL), for accessing a particular web site, web page, or other data network accessible content. The web browser application may also implement a web browser bookmark reconciliation engine of the illustrative embodiments for detecting when such a bookmark is no longer current, i.e. the bookmark no longer points to or otherwise is able to be used to access the original content with which the bookmark was associated. This may occur, for example, if the content with which the bookmark was associated has been moved to another location, or simply is no longer available, for example.

For example, assume that one of the servers 104, 106 is a web server providing content, such as web pages, files, or the like, to client computing devices 110-114 via the at least one data network 102. A client computing device, such as client 110, may navigate the content available via the one or more data network 102 to access the content available from the web server 104, for example, and may select an option in their web browser application to create a bookmark, shortcut, link, or otherwise store an address or URL for the content so that it may be quickly accessed again via the web browser application by simply selecting the bookmark. At some time after the client computing device 110 stores the bookmark, the content provided by the web server 104 may be moved or no longer associated with the original location of the content associated with the bookmark.

The illustrative embodiments provide mechanisms for performing web browser bookmark reconciliation. The mechanisms of the illustrative embodiments automatically reconcile the bookmarked web pages, files, or other content available from servers via one or more data networks, by processing the corresponding web browser application's history data structure, which identifies the content accessed by a user of the browser application over predetermined periods of time, and bookmarks to discover the correct URL, link, or other address to be associated with a bookmark whenever the original bookmarked content cannot be found, i.e. the current bookmark is no longer accurate.

For purposes of the illustrative embodiments, it will be assumed that the content being accessed is a web page and the bookmarks store URLs for accessing such web pages. In one illustrative embodiment, the mechanisms of the illustrative embodiments leverage the web page header to associate with a discovered URL its relative reliability. This automated mechanism resolves the ambiguities of the local web browser bookmarks without requiring any change to the web servers or the web pages themselves.

With the mechanisms of the illustrative embodiments, when a user opens his/her web browser application and selects a bookmark from a bookmark list in the web browser application's user interface, the selection of the bookmark causes the web browser application to enter the corresponding URL in the navigation bar of the web browser application's user interface, thereby causing the computing device to transmit a request for the corresponding web page from the web server corresponding to the URL. A determination is made as to whether the web page corresponding to the URL is correctly retrieved by the web browser application (hereafter simply referred to as the “web browser”). As mentioned above, if a return code is different from a known code indicative of a correct retrieval of a web page, e.g., “200,” then a determination is made to see if the HTTP return code indicates an error in retrieving the web page. For example, this may be the HTTP return code “404” which indicates that a web page matching the URL was not able to be found by the web server. If the return code is something other than these two possible responses, e.g., “200” or “404”, then the web browser will continue to process the web page request and returned web page content in accordance with a conventional operation generally known in the art.

In the event that the return code is “404”, the bookmark reconciliation engine of the corresponding web browser application is invoked in accordance with the illustrative embodiments. The bookmark reconciliation engine performs a search to find a replacement URL for the bookmark that led to the return code of “404.” In order to identify the replacement URL, the bookmark reconciliation engine performs a search of the web browser's history data structure based on information about the bookmark and its previous URL which is determined to be “broken.” This information may take many different forms but includes keywords, title information, URL, last visit date, visit count, and the like. This information may be used to perform matching operations with corresponding information associated with other URLs in the web browser history. Based on these matching operations, a replacement URL, link, or address for the broken bookmark may be selected and associated with the existing bookmark or a replacement bookmark may be generated and stored in replacement of the existing broken bookmark.

Various weightings may be associated with different parameters in this information based on a relative importance applied to these parameters. A confidence level value may be calculated for each of these other URLs based on these weighted parameter values.

In one illustrative embodiment, the confidence level may be used to automatically select a replacement URL for the bookmark, e.g., a URL having a highest confidence level may be selected. In another illustrative embodiment, the confidence levels of the various URLs may be used to generate and present to a user a listing of potential replacement URLs from which the user may select a replacement URL for the bookmark. The generation and presentation of such a listing may be limited to only URLs whose confidence level is above a predetermined threshold value. Based on a user's manual selection of a replacement URL for the bookmark, the bookmark may be updated to be associated with the replacement URL or may be deleted and replaced with a new bookmark corresponding to the replacement URL.

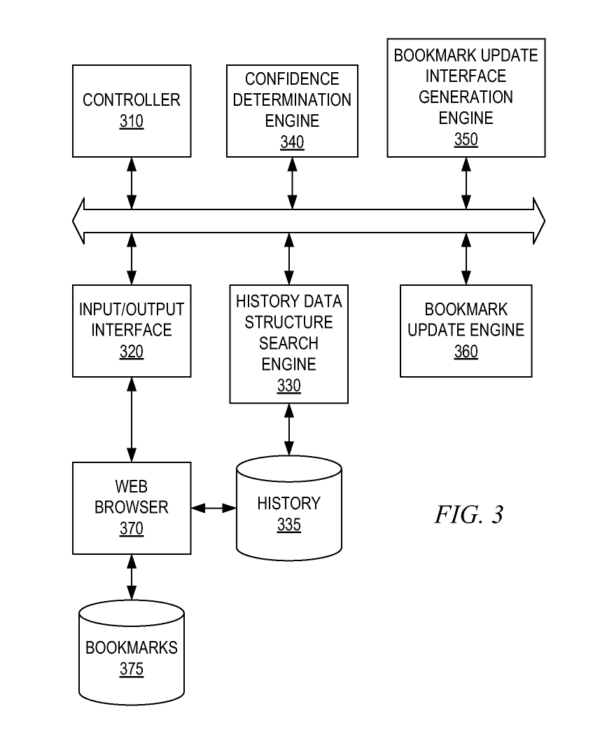

FIG. 3 is an example block diagram of the primary operational elements of a client computing device and web browser in accordance with one illustrative embodiment. The elements shown in FIG. 3 may be implemented as software instructions loaded into one or more memories and executed by one or more processors of a data processing system. In one illustrative embodiment, the elements of FIG. 3 may be implemented as a plug-in or addition to a web browser application, or other network content accessibility application.

As shown in FIG. 3, the primary operational elements of a bookmark reconciliation engine 300 comprises a controller 310, an input/output interface 320, a history data structure search engine 330, a confidence determination engine 340, a bookmark update interface generation engine 350, and a bookmark update engine 360. The controller 310 controls the overall operation of the bookmark reconciliation engine 300 and orchestrates the operation of the other elements 320-350. The input/output interface 320 provides a data communication path through which a bookmark may be input to the bookmark reconciliation engine 300, such as in response to a user selecting a bookmark from the bookmarks data structure 375 via a web browser application 370, and one or more corresponding replacements or updates to the bookmark may be output via a user interface that may be generated by the bookmark update interface generation engine 350.

The history data structure search engine 330 searches the history data structure 335 associated with a web browser application for candidate URLs to replace the URL of the bookmark input to the reconciliation engine 300 and returns a listing of candidate URLs. The confidence determination engine 340 evaluates the candidate URL characteristics against the characteristics of the input bookmark to determine a degree of matching and a confidence measure value indicating a confidence that the corresponding candidate URL can replace the input bookmark's URL. These confidence measure values may be compared against one or more predetermined threshold confidence values indicating a minimum level of confidence required to consider the candidate URL a potential replacement for the input bookmark's URL. The resulting subset of candidate URLs may then be returned by the confidence determination engine 340 for use by the bookmark update interface generation engine 350 in presenting a user interface through which a user may select a candidate URL that the user wishes to use to replace the existing input bookmark's URL or to replace the bookmark altogether. Alternatively, an automated mechanism may be utilized that automatically selects and updates the input bookmark, or replaces the input bookmark altogether, based on a candidate URL in the subset of candidate URLs having a highest confidence measure value.

The bookmark update engine 360 takes the selected candidate URL to replace the existing URL for the input bookmark and updates the bookmark in the bookmark data structure to be associated with the new selected candidate URL. Alternatively, the bookmark as a whole may be replaced such that the original bookmark is no longer present in the bookmark data structure and instead, a new bookmark is created that is associated with the selected candidate URL. The replacement bookmark may be located in a same location as the input bookmark within the listing of bookmarks in the bookmark data structure.

To further illustrate the operation of the bookmark reconciliation engine 300, consider a scenario in which a user initiates their web browser on their client computing device and selects a bookmark from their bookmark listing in the web browser's interface. In response to the selection of this bookmark, the web browser attempts to retrieve the content corresponding to the bookmark from the location identified by the URL associated with the bookmark. The web browser causes the client computing device to transmit an HTTP request to the web server corresponding to the URL associated with the bookmark.

The web browser receives a response back from the web server, or in response to a timeout condition, that indicates whether the requested content, e.g., a web page, was able to be returned successfully or not. If the response indicates that the web page was returned successfully, then the web browser operates in a normal fashion. If the web browser was not returned successfully, then a determination is made as to whether the response indicates that the URL is not longer accurate, i.e. the URL, and its corresponding bookmark, are broken, e.g., the return code is “404” in known HTTP. If not, then the web browser handles the unsuccessful response in a manner generally known in the art. However, if the unsuccessful response indicates a broken URL and bookmark, then the web browser invokes the operation of the bookmark reconciliation engine 300. Thus, the bookmark reconciliation engine 300 is initiated in response to a bookmark being selected by a user via the web browser and the resulting response indicates that the URL and bookmark are broken.

The broken bookmark and all of its characteristic information, e.g., keywords, title, URL, last successful visit date/time, successful visit count, and the like, as stored in the web browser's history data structure 355 or other data structure associated with the bookmark data structure 355, is input to the bookmark reconciliation engine 300 via the input/output interface 320. This information is input to the history data structure search engine 330 which may work in concert with the confidence determination engine 340 to calculate confidence measure values for candidate replacement URLs for the broken bookmark and select a set of candidate replacement URLs from which a replacement URL may be selected to actually replace the URL and/or the bookmark as a whole.

To perform the search of the history data structure 355, the history data structure search engine 330 may make use of any of a plurality of different types of algorithms to implement the search. An initial search of the history data structure 355 may be made based on one or more characteristics of the broken bookmark and characteristics associated with the URLs of the entries in the history data structure 355. For example, URLs may be compared initially to determine if there are any URLs in the history data structure 355 that are in a same domain as the URL of the broken bookmark in order to identify a set of candidate replacement URLs. Alternatively, a title associated with the broken URL may be compared to titles associated with URLs in the history data structure 355 to select an initial set of candidate URLs that have similar titles. This can be done based on a word matching criteria where any URLs in the history data structure 355 having a matching word (other than articles or other standard words that are determined to not be indicative of content) may be selected for inclusion in the initial set of candidate replacement URLs.

After the initial set of candidate replacement URLs is selected, or alternative to such an initial search of the history data structure 355, confidence measure values may be calculated based on the characteristics associated with the broken bookmark and corresponding characteristics associated with the URLs in the history data structure to determine a degree of matching between these characteristics. A confidence measure value may be calculated for each of the candidate replacement URLs, either from the initial set identified or simply from all of the URLs in the history data structure, based on a degree of matching of the characteristic of the broken bookmark with the corresponding characteristic associated with the candidate replacement URL. The confidence measure value may be compared against one or more minimum confidence measure values. If the confidence measure value meets or exceeds the one or more minimum confidence measure values, then the corresponding candidate replacement URL may be included in a subset of candidate replacement URLs for consideration in replacing the URL of the bookmark, or for replacing the bookmark as a whole.

For example, consider a bookmark having the following bookmark header information:

```
<! -- Bookmark -- >
<HEAD>
    <TITLE>Title1</TITLE>
    <META name=”keywords” content=“A, B, C, D” />
</HEAD>
...
```

Further assume that the browser history data structure has the following two web page entries stored in it:

```
<! -- history 1 -- >
<HEAD>
    <TITLE>Title1</TITLE>
    <META name=”keywords” content=“A, B” />
</HEAD>
...
<! -- history 2 -- >
<HEAD>
    <TITLE>Title2</TITLE>
    <META name=”keywords” content=“A, C, D” />
</HEAD>
...
```

With this example, different weightings of confidence values may be associated with different sections or characteristics identified in the bookmark and history data structure entries. These weightings may be configurable based on user input, for example. As one example, a degree of matching between the titles may be weighted at 80% weight while a degree of matching between the keywords may be weighted at 20% weight. This is only an example and any number of characteristics, sections, and weightings over different amounts and types may be used without departing from the spirit and scope of the illustrative embodiments.

Returning to the above example, the confidence measurement value for the history 1 entry in the history data structure 355, i.e. the first of the web pages that are potential replacements for the URL of the broken bookmark, may be calculated as C1=80*1/1+20*2/4=90%, where C1 is the confidence measurement value for the history 1 entry, 1/1 indicates the number of matching title terms out of the total number of possible matching terms, i.e. 1 title term out of a total of 1 title term is matched by the title of history 1, and 2/4 indicates the number of matching keywords out of the total possible number of matching keywords, i.e. 2 out of the 4 keywords associated with the broken bookmark are matched by the keywords associated with history 1. A similar confidence measure value may be calculated for history 2 in the history data structure as C2=80*0/1+20*3/4=15%.

These confidence measure values may be compared to a predetermined threshold minimum confidence measure value to indicate if they should be kept in a subset of candidate replacement URLs for the broken bookmark. For example, if a threshold minimum confidence measure value is 20%, then history 1 satisfies this minimum because it is equal to or greater than 20%, i.e. 90%. However, history 2 does not satisfy this minimum because it is less than the threshold of 20% and thus, will not be maintained as a candidate replacement URL for the broken bookmark. This results in a subset of candidate replacement URLs that may be presented to a user for selection of a URL to replace the URL of the bookmark or for generation of a replacement bookmark entirely.

Alternatively, in an automated mechanism, rather than selecting a subset of candidate replacement URLs for the broken bookmark by comparing the confidence measure values to a predetermined minimum threshold value, the calculated confidence measure values may be compared to each other to determine the candidate replacement URL having the highest confidence measure value. The candidate replacement URL having the highest confidence measure value may then be selected to replace the URL of the broken bookmark, or for use in generating a new bookmark to replace the broken bookmark. If there is a tie between candidate replacement URLs, sub-factors in the calculation of the confidence measure value may be individually evaluated to determine which of the tied candidate replacement URLs to select, e.g., look at the titles to see which has a title having a highest degree of matching, look at the keywords to see which has a highest degree of matching, or the like. If there is still a tie after looking at the individual components of the confidence measure value in accordance with a configured ranking of the components, e.g., first look at the title to see if there is no tie, then look at the keywords to see if there is no tie, etc., then one of the tied candidate replacement URLs may simply be selected arbitrarily, e.g., at random.

In an embodiment in which the replacement URL is not selected automatically based on the confidence measure values and a user selection is desired, the subset of candidate replacement URLs may be provided to the bookmark update interface generation engine 350 to generate a bookmark update interface through which the user is present information regarding the various candidate replacement URLs in the subset and given a graphical user interface through which the user may select one of the candidate replacement URLs to be the actual replacement URL for the broken bookmark. The user interface may be presented to the user via their client computing device in response to the user interface rendering data being transmitted by the bookmark reconciliation engine 300 to the client computing device via the input/output interface 320. The user's selection may likewise be received via the input/output interface 320.

In response to the user's selection of a candidate replacement URL to be the actual replacement URL, the user selection is provided to the bookmark update engine 360 which interfaces with the web browser application 370 to update the web browser application's bookmark data structure 375 to reflect the user's selection of a replacement URL. This update of the bookmark data structure 375 may be to replace the URL associated with the bookmark but otherwise leaving the bookmark intact. In other illustrative embodiments, the update may be to remove the broken bookmark from the bookmark data structure 375 and replace it with a new bookmark entry in the bookmark data structure 375 that corresponds to the selected replacement URL. In still another illustrative embodiment, the option to update or replace the broken bookmark may be provided to the user via the generated bookmark update interface and the user's selection of one of these options may be returned with the user's selection of a replacement URL.

Thus, the illustrative embodiments provide mechanisms for reconciling broken bookmarks in a web browser's bookmark data structure 375. The illustrative embodiments process the web browser's history data structure 335 and bookmarks to discover an adequate replacement for the broken bookmark. The mechanisms of the illustrative embodiments leverage the characteristic information associated with bookmarks and entries in history data structures 335 to determine a confidence measure that an entry in the history data structure 335 is a satisfactory replacement for the broken bookmark. As a result, the mechanisms of the illustrative embodiments maintain the local bookmark data structure 375 reliable and reduces duplicate bookmarks where some are broken and another is valid for the same content, e.g., same web page. The mechanisms of the illustrative embodiments are able to be implemented without having to change the web servers or the web pages themselves and may be implemented in a web browser 370 directly or as an addition to a web browser 370, such as a plug-in, or the like.

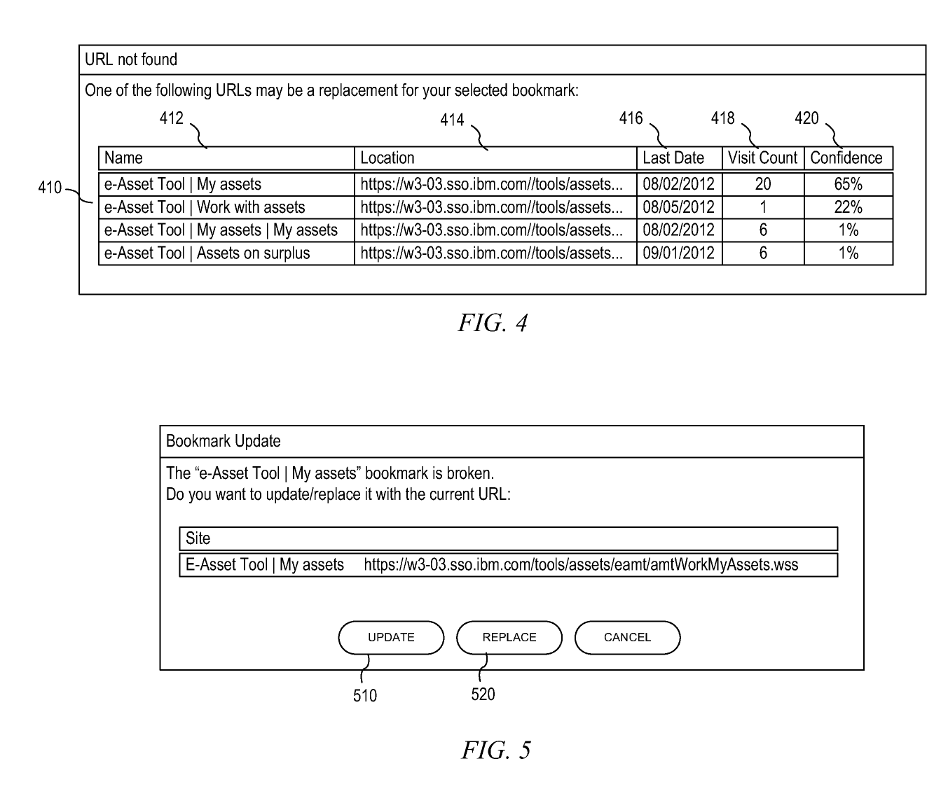

FIG. 4 is an example diagram of a listing of potential replacement web page URLs in accordance with one illustrative embodiment. As shown in FIG. 4, the listing of potential replacement web page URLs, or candidate replacement URLs, includes one or more entries 410 having various characteristics about the candidate replacement URLs being presented. These characteristics include a name 412, a location 414, a last visit date 416, a visit count 418, and a corresponding confidence measure value 420. This listing of candidate replacement URLs may be generated, for example, by the bookmark update interface generation engine 350, for example, based on the confident measure values calculated for the candidate replacement URLs by the confidence determination engine 340 as part of performing the history data structure search by the history data structure search engine 330.

In the depicted example, rather than limiting the listing to only those candidate replacement URLs that have a confidence measure value meeting or exceeding a minimum threshold value, all of the candidate replacement URLs are listed (and thus, even those having a confidence measure value of “1” are listed). It should be appreciated that in other illustrative embodiments, this listing may be further pared or filtered based on one or more minimum confidence measure values.

From this listing, a candidate replacement URL may be selected by a user to be an actual replacement URL for the broken bookmark. The selection of such a replacement URL may cause a second user interface to be generated by the bookmark update interface generation engine 350 such as depicted in FIG. 5, for example.

FIG. 5 is an example diagram of a bookmark update user interface in accordance with one illustrative embodiment. The bookmark update user interface of FIG. 5 may be generated in response to the user selecting a replacement URL in the interface of FIG. 4, or in response to an automated embodiment selecting the replacement URL automatically based on relative confidence measure values, as previously described above. The interface 500 allows a user to confirm the user's desire to update the broken bookmark based on the selected replacement URL. Moreover, in one illustrative embodiment, the interface 500 comprises user selectable options 510 and 520 for selecting whether to update the existing broken bookmark or replace the existing broken bookmark with a new bookmark, such as in the case where the replacement URL is not an exact match for the broken bookmark.

In still another illustrative embodiment, although not explicitly shown in FIG. 5, the bookmark reconciliation engine 300 may interface with the web browser application to cause the web page associated with the replacement URL to be rendered in a window or instance of the web browser application on the client computing device so that the user may view the web page before selecting an option in the user interface in FIG. 5. Thus, user is presented with information regarding the replacement URL as well as the content associated with the replacement URL so that the user can make an informed decision as to whether to update, replace, or cancel the reconciliation operation.

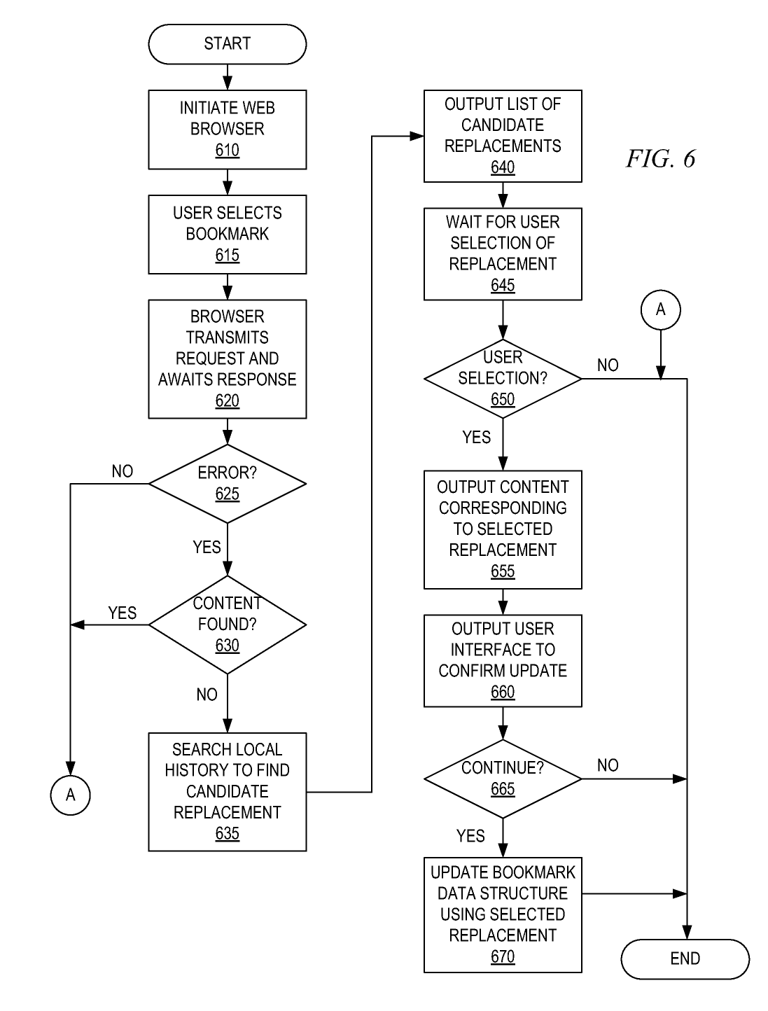

FIG. 6 is a flowchart outlining an example operation of a bookmark reconciliation engine in accordance with one illustrative embodiment. The operation outlined in FIG. 6 may be implemented, for example, by a bookmark reconciliation engine 300 in FIG. 3. This operation outlines one possible implementation of one illustrative embodiment. However, it should not be construed to be limiting as to the possible implementations and possible embodiments of the present invention. FIG. 6 is only provided as one example and many modifications to the operation outlined in FIG. 6 may be made without departing from the spirit and scope of the illustrative embodiments or present invention.

As shown in FIG. 6, the operation starts with a user initiating their web browser application on their client computing device (step 610). The user selects a bookmark from the bookmark listing in the web browser application's interface (step 615). The web browser application, in response to the selection of the bookmark, transmits a request for the corresponding web content using the URL associated with the selected bookmark and waits for a response (step 620). A determination is made as to whether the web content was received and rendered correctly in the web browser (step 625). If so, then the operation terminates. If not, then a determination is made as to whether the response from the web server indicates that the content corresponding to the URL of the bookmark could not be found, e.g., return code “404” is received (step 630). If not, then the operation terminates with the web browser handling the response in a known manner.

If the response received from the web server indicates that the content corresponding to the URL of the bookmark could not be found, i.e. the bookmark is a broken bookmark, then a search of the local history data structure is performed to find a set of candidate replacement URLs for the broken bookmark based on calculated confidence measure values for the candidate replacement URLs in the local history data structure (step 635). The web browser may then output a list of the set of candidate replacement URLs (step 640) and waits for a user input selecting a replacement URL from the listing of candidate replacement URLs (step 645). If a user selection is not received within a specified time frame, or the user selects to cancel the reconciliation operation, then the operation terminates. If the user selects a candidate replacement URL to be the actual replacement URL (step 650), the corresponding web content may be output (step 655) and a user interface for confirming the user's selection to update the broken bookmark is presented (step 660). A determination is made as to whether the user selects to continue the update of the broken bookmark or to cancel the reconciliation operation (step 665). If the user selects to update the broken bookmark, then the bookmark data structure is updated based on the selected replacement URL (step 670); otherwise the operation terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for reconciling a broken bookmark in a web browser application executing on the data processing system, comprising:
receiving, in the data processing system, a selection of a bookmark from a bookmark listing of the web browser application;
determining, by the data processing system, that the selected bookmark is broken in response to an original reference to content associated with the selected bookmark not resulting in the content being retrievable;
performing, by the data processing system, in response to the determination that the selected bookmark is broken, a search of a local history data structure of the web browser application for a replacement reference to content to replace the original reference to content associated with the selected bookmark; and
updating, by the data processing system, the selected bookmark based on the replacement reference to content.

2. The method of claim 1, wherein determining that the selected bookmark is broken comprises:
transmitting a request for content to a content source associated with the original reference to content corresponding to the selected bookmark;
receiving a response from the content source; and
determining whether the response from the content source indicates that the content associated with the reference to content could not be provided by the content source in response to the request.

3. The method of claim 2, wherein determining whether the response from the content source indicates that the content associated with the reference to content could not be provided by the content source comprises determining whether a response code in the response from the content source is a 404 response code.

4. The method of claim 1, wherein performing the search of the local history data structure comprises:
determining bookmark characteristic information associated with the selected bookmark and its associated original reference to content;
performing a matching operation for matching the bookmark characteristic information with characteristic information for entries in the local history data structure to identify one or more candidate replacement references to content; and
selecting a replacement reference to content from the one or more candidate replacement references to content based on results of the matching operation.

5. The method of claim 4, wherein the bookmark characteristic information comprises at least one of a title associated with the selected bookmark, one or more keywords associated with the selected bookmark, one or more portions of a Uniform Resource Locator (URL) associated with the selected bookmark, a last visit date associated with the selected bookmark, or a visit count associated with the selected bookmark.

6. The method of claim 4, wherein performing a matching operation further comprises:
calculating, for each entry in the local history data structure, a confidence level value indicating a level of confidence that the entry has an associated reference to content that is a suitable replacement for the original reference to content associated with the selected bookmark.

7. The method of claim 6, wherein calculating the confidence level value comprises applying different weights to different bookmark characteristic information evaluated in the calculation of the confident level value.

8. The method of claim 6, wherein selecting a replacement reference to content from the one or more candidate replacement references to content based on results of the matching operation further comprises:
selecting the one or more candidate replacement references to content from the entries in the local history data structure based on the calculated confidence levels of the entries in the local history data structure by comparing the calculated confidence levels of the entries to a threshold confidence level value and selecting the one or more candidate replacement references as those references to content associated with entries having an associated confidence level equal to or greater than the threshold confidence level value.

9. The method of claim 6, wherein selecting a replacement reference to content from the one or more candidate replacement references to content based on results of the matching operation further comprises:
automatically selecting a candidate replacement reference to content, from the one or more candidate replacement references to content, having a highest associated confidence level value.

10. The method of claim 6, wherein selecting a replacement reference to content from the one or more candidate replacement references to content based on results of the matching operation further comprises:
presenting an output to a user indicating the one or more candidate replacement references to content and their associated confidence level values;
receiving a user selection of a selected candidate replacement reference to content from the one or more candidate replacement references to content in response to presenting the output to the user; and
utilizing the selected candidate replacement reference to content as the replacement reference to content for the selected bookmark.

11. The method of claim 1, wherein updating the selected bookmark based on the replacement reference to content comprises replacing the original reference to content associated with the selected bookmark in the bookmark listing of the web browser application.

12. The method of claim 1, wherein updating the selected bookmark based on the replacement reference to content comprises deleting the selected bookmark and replacing the selected bookmark with a new bookmark, corresponding to the replacement reference to content, in the bookmark listing of the web browser application.

13. A computer program product comprising a computer readable storage medium having a computer readable program stored therein, wherein the computer readable program, when executed on a computing device, causes the computing device to:
receive a selection of a bookmark from a bookmark listing of a web browser application;
determine that the selected bookmark is broken in response to an original reference to content associated with the selected bookmark not resulting in the content being retrievable;
perform, in response to the determination that the selected bookmark is broken, a search of a local history data structure of the web browser application for a replacement reference to content to replace the original reference to content associated with the selected bookmark; and
update the selected bookmark based on the replacement reference to content.

14. The computer program product of claim 13, wherein determining that the selected bookmark is broken comprises:
transmitting a request for content to a content source associated with the original reference to content corresponding to the selected bookmark;
receiving a response from the content source; and
determining whether the response from the content source indicates that the content associated with the reference to content could not be provided by the content source in response to the request.

15. The computer program product of claim 14, wherein determining whether the response from the content source indicates that the content associated with the reference to content could not be provided by the content source comprises determining whether a response code in the response from the content source is a 404 response code.

16. The computer program product of claim 13, wherein performing the search of the local history data structure comprises:
determining bookmark characteristic information associated with the selected bookmark and its associated original reference to content;
performing a matching operation for matching the bookmark characteristic information with characteristic information for entries in the local history data structure to identify one or more candidate replacement references to content; and
selecting a replacement reference to content from the one or more candidate replacement references to content based on results of the matching operation.

17. The computer program product of claim 16, wherein the bookmark characteristic information comprises at least one of a title associated with the selected bookmark, one or more keywords associated with the selected bookmark, one or more portions of a Uniform Resource Locator (URL) associated with the selected bookmark, a last visit date associated with the selected bookmark, or a visit count associated with the selected bookmark.

18. The computer program product of claim 16, wherein performing a matching operation further comprises:
calculating, for each entry in the local history data structure, a confidence level value indicating a level of confidence that the entry has an associated reference to content that is a suitable replacement for the original reference to content associated with the selected bookmark.

19. The computer program product of claim 18, wherein calculating the confidence level value comprises applying different weights to different bookmark characteristic information evaluated in the calculation of the confident level value.

20. The computer program product of claim 18, wherein selecting a replacement reference to content from the one or more candidate replacement references to content based on results of the matching operation further comprises:
selecting the one or more candidate replacement references to content from the entries in the local history data structure based on the calculated confidence levels of the entries in the local history data structure by comparing the calculated confidence levels of the entries to a threshold confidence level value and selecting the one or more candidate replacement references as those references to content associated with entries having an associated confidence level equal to or greater than the threshold confidence level value.

21. The computer program product of claim 18, wherein selecting a replacement reference to content from the one or more candidate replacement references to content based on results of the matching operation further comprises:
automatically selecting a candidate replacement reference to content, from the one or more candidate replacement references to content, having a highest associated confidence level value.

22. The computer program product of claim 18, wherein selecting a replacement reference to content from the one or more candidate replacement references to content based on results of the matching operation further comprises:
presenting an output to a user indicating the one or more candidate replacement references to content and their associated confidence level values;
receiving a user selection of a selected candidate replacement reference to content from the one or more candidate replacement references to content in response to presenting the output to the user; and
utilizing the selected candidate replacement reference to content as the replacement reference to content for the selected bookmark.

23. The computer program product of claim 13, wherein updating the selected bookmark based on the replacement reference to content comprises replacing the original reference to content associated with the selected bookmark in the bookmark listing of the web browser application.

24. The computer program product of claim 13, wherein updating the selected bookmark based on the replacement reference to content comprises deleting the selected bookmark and replacing the selected bookmark with a new bookmark, corresponding to the replacement reference to content, in the bookmark listing of the web browser application.

25. An apparatus, comprising:
a processor; and
a memory coupled to the processor, wherein the memory comprises instructions which, when executed by the processor, cause the processor to:
receive a selection of a bookmark from a bookmark listing of a web browser application;
determine that the selected bookmark is broken in response to an original reference to content associated with the selected bookmark not resulting in the content being retrievable;
perform, in response to the determination that the selected bookmark is broken, a search of a local history data structure of the web browser application for a replacement reference to content to replace the original reference to content associated with the selected bookmark; and
update the selected bookmark based on the replacement reference to content.
